(19) United States
(12) Patent Application Publication
(10) Pub. No.: US 2004/0242194 A1
(43) Pub. Date: Dec. 2, 2004

(54) Information gathering

(76) Inventor: Roy George Taylor, Wellington (NZ)

Correspondence Address: O M (SAM) Zaghmout, Bio Intellectual Property Services, 8509 Kernon Ct, Lorton, VA, 22079, US

(21) Appl. No.: 10/489,618

(22) PCT Filed: Sep. 23, 2002
(86) PCT No.: PCT/NZ02/00190

(30) Foreign Application Priority Data
Sep. 24, 2001 (NZ) 514396
Aug. 5, 2002 (NZ) 520555

(51) Int. Cl. H04M 3/16

(52) U.S. Cl. 455/410; 455/411

(57) ABSTRACT

According to the invention there is provided a process for forming a profile of actual or potential unlawful acts, or actual or suspected perpetrators thereof, comprising the steps of: i) arranging a processor means such that it is able to receive communications from subscribers or users of a communications network, ii) receiving communications at the processor means from communications devices of the subscribers or users, the communications each comprising information as to an actual or potential unlawful act, iii) processing the information by way of the processor means such that a profile is developed to characterise the act and/or the actual or suspected perpetrators(s) of the act, and iv) reporting the profile to an interested authority. The communications devices mentioned at step ii) may be mobile telephones, and the interested authority may be a law renforcement authority.

### FIELD OF INVENTION

This invention relates to a process for gathering information. A particularly preferred form of the invention relates to a process for forming a profile of actual or potential unlawful acts, and/or actual or suspected perpetrators thereof.

### BACKGROUND

A problem with identifying, and if appropriate capturing, the perpetrators of unlawful acts, including terrorist activities, general criminal activities, and traffic offences, is that the perpetrators can move from the scene of an offence rather quickly and be difficult to track. In some cases perpetrators may induce a terrorist or other criminal act from a remote area, and thus finding information to link them to the act can be difficult. It is accordingly an object of at least one form of the present invention to provide a process which facilitates gathering information on actual or potential perpetrators of an unlawful act, or to at least provide the public with a useful choice.

The term “comprise”, “comprises”, “comprised” or “comprising”, if and when used in this document, should be interpreted non-exclusively, i.e. should be interpreted non-exclusively—to mean “consisting of or including”.

### GENERAL DESCRIPTION

According to one aspect of the invention there is provided a process for forming a profile of actual or potential unlawful acts, or actual or suspected perpetrators thereof, comprising the steps of:

i) arranging a processor means such that it is able to receive communications from subscribers or users of a communications network,

ii) receiving communications at the processor means from communications devices of the subscribers or users, the communications each comprising information as to an actual or potential unlawful act,

iii) processing the information by way of the processor means such that a profile is developed to characterise the act and/or the actual or suspected perpetrator(s) of the act, and

iv) reporting the profile to an interested authority.

Optionally the communications devices are mobile communications devices.

Optionally the communications devices mentioned at step ii) comprise mobile telephones (eg cellular telephones).

Optionally the communications devices mentioned at step ii) comprise WAP phones.

Optionally the communications devices mentioned at step ii) comprise palmtop computers or the like.

Optionally at least some of the communications received at the processor means at step ii) are in a non-voice digital form.

Optionally at least some of the communications received at the processor means at step ii) are in the form of text messages.

Optionally the communications received at the processor at step ii) are in a voice form but are subsequently converted to a digital form by voice recognition means within the processor means.

Optionally the processing of the information at step iii) involves:

a) comparing the information from at least some of the communications against predetermined criteria to ascertain whether the information is a match against such criteria, and/or

b) comparing the information from at least some of the communications with information from others of the communications to ascertain a match therebetween,

and using the match or matches to substantially electronically develop the profile.

Optionally at least some of the communications devices have a screen viewable menu for enabling selection of categories of unlawful acts such that when a category is selected at one of the communications devices, subsequent communications from that communications device are received at the processor means at step ii) with an indicator as to which category was selected.

Optionally the screen viewable menu can be downloaded to at least some of the communications devices from the processor means.

Optionally the processor means comprises a computer or a number of interlinked computers.

Optionally the process comprises the further step of the processor means contacting at least some of the subscribers or users by way of their communications devices and requesting or prompting for additional information regarding the actual or potential unlawful act that they communicated to the processor means at step ii), and then receiving and processing a response from those subscribers or users.

Optionally said further step occurs before and/or after step iii).

Optionally the said further step involves sending the subscribers or users a communications device screen viewable question or questions which can be answered by manipulating keypad keys of the respective communications device.

Optionally said further step involves sending images of suspected perpetrators, places, or objects considered potentially relevant to an unlawful act under investigation by the interested authority.

Optionally at least some of the subscribers or users are automatically identified by the processor means when such subscribers or users send communications to the processor means.

Optionally the processing of the information at step iii) involves assessing the reliability of information from the communications received at the processor means, and discarding information from certain of the subscribers or users if it is deemed unreliable.

Optionally the processor means keeps a record of at least some of the subscribers or users who have provided information to the processor means and allocates such subscribers or users to receive compensation for participation in the process.

Optionally the compensation comprises a chance to win a prize in a lottery.

Optionally the profile is communicated to a further interested authority and is assessed against information held by that further authority to enhance or supplement the profile.

Optionally the interested authority is, or if appropriate the interested authorities are each, a law enforcement authority.

Optionally the processor means stores a case history of actual or suspected perpetrators of unlawful acts based on the communications received at step ii).

According to a further aspect of the invention the process involves also:

i) arranging the processor means to maintain a medical database of patients being monitored in terms of their medical condition,

ii) receiving medical communications for the patients at the processor means, the medical communications each containing update medical information personal to the respective patient,

iii) processing the update medical information and updating the medical database for the respective patient, and

iv) reporting updated database details for at least some of the patients.

Optionally the medical communications from the patients are received at the processor means by way of telephonic communications—eg from mobile telephones or palmtop computers having a menu prompting for specific patient information.

The update medical information may give the patient's heart rate, blood pressure, body temperature, blood sugar level, etc.

Optionally the processor means registers and reports an alert to a medical professional if, after the processor means has processed a patient's update medical information, details for that patient as stored in the database indicate that the patient is in need of medical attention.

According to a further aspect of the invention the process also involves:

i) receiving political communications from members of the public at the processor means, the political communications each containing political information as to which political candidate and/or which political party the members of the public intend to vote for at an upcoming political election,

ii) processing the political information to obtain a political opinion poll result, and

iii) reporting the opinion poll result to an interested party.

Preferably the political communications are received at the processor means by way of mobile telephones each having an on-screen menu prompting for specific political information.

According to a further aspect of the invention the process also involves:

i) receiving consumer product or service communications from consumers at the processor means, the consumer product or service communications containing preference information as to the consumer's preferences with regard to specific products or services,

ii) processing the preference information to obtain a consumer product or service market report, and

iii) reporting the market report to an interested party.

Preferably the product or service communications are received at the processor means by way of mobile telephones each having an on-screen menu prompting for specific product or service related information.

According to another aspect of the invention there is provided an item of software forming part of the processor means, or for combining with the processor means, such that the processor means functions to achieve the process set out above.

It will be appreciated that it is possible for the medical database aspect, the political opinion poll aspect, and the product or service market report aspect, to exist independently of one another and independently of the unlawful act/unlawful act perpetrator profiling aspect.

### BRIEF DESCRIPTION OF FIG. 1

FIG. 1 shows mobile telephone menu details in accordance with one specific embodiment of the invention.

### DETAILED DESCRIPTION

In a preferred embodiment of the invention subscribers or users of a mobile telephone network are provided with mobile telephones which have the necessary hardware and software to enable communication with a central processor. The mobile telephones may be pre-programmed to have a menu for use in sending digital (non-voice) communications to the central processor relating to actual or potential unlawful acts. For example, the menu of each mobile telephone may have a screen showing the following selections possible by way of the telephone's key pad:

1. Terrorism

2. Murder

3. Property Risk

4. Dangerous Driving

5. Fisheries

If a subscriber or user of the telephone network observes an actual or potential act of terrorism, whether suspected or otherwise, the subscriber or user may push the “1” key on his or her mobile telephone. The menu may then display the following screen data for facilitating the input of information by Way of the keypad:

Suspect Name=

Vehicle Registration=

Street Address=

Suspect Telephone Number=

Your Contact=

Message=

It will of course be appreciated that other menu arrangements can be utilised without departing from the scope of the invention.

By further using the mobile telephone's key pad the subscriber may enter the information queued for. The information may then be sent to the central processor via a cellular or other suitable communications link. The central processor then processes the information and, if appropriate, communicates it to the military or to a civil law enforcement agency, either directly or indirectly.

In some embodiments of the invention the mobile telephones may communicate with the central processor by way of a text messaging facility, and/or may communicate with a web site which may form at least part of the central processor.

It will be appreciated from the above that the invention facilitates the fast and efficient gathering of information on an actual or potential unlawful act on an extremely large scale, and this information may be used for forming a profile—eg for identifying and apprehending perpetrators, as well as identifying witnesses for use in Court proceedings. Because the information sent by the subscribers or users of the mobile telephone network is received by the central processor in an electronic format, it can be processed and manipulated with very little or no human effort. Additionally, the processor can make an estimate as to accuracy or reliability of the information sent by subscribers or, users based on whether it is consistent with basic pre-set criteria, or with the information sent by other subscribers or users.

The invention can be arranged to facilitate multi-tier questions. For example, once a subscriber or user has sent information by way of mobile telephone they may receive a return call or calls requesting specific additional information and/or prompting for further information. This may have the effect of stimulating the thought processes and memory of the subscriber or user concerned to obtain a more focussed response. For example, if a subscriber or user initially reports on a kidnapping, or on being in the area of a suspected kidnapping, the subscriber's or user's contact details are stored. That subscriber or user may be subsequently contacted via their mobile, telephone with a message prompting for specific information such as, “did you see a blue car at or near the scene of the crime”. If the subscriber's or user's response to this question is “yes”, then they can be prompted to answer additional questions related to the car—eg details of the registration number, the appearance of the driver, the time the car was seen, etc. Subscribers or users may also be shown images of suspected perpetrators of criminal acts, of missing persons, of vehicles, etc, by way of their mobile telephones, together with questions relating to the images. In some embodiments of the invention contact to subscribers or users may be completely without solicitation if the situation merits this. The contact may be to subscribers or users who are registered as residing near the scene of a crime, or who have been determined by the central processor as being at or near the scene of a crime at the material time. This may be facilitated by electronic geographical positioning means forming part of the mobile phones and/or the central processor.

In some embodiments of the invention telephonic questions and answers are given and received using electronic voice recognition rather than by way of text communications.

The information gathered by the central processor can be retained, and can be interrogated to ascertain the number of times an actual or potential perpetrator has committed, or has been suspected of committing, an unlawful act. The information can also be used to develop profiles on perpetrators and places. Information from the central processor may be reported with maps, graphs/pie charts, route plans, time history details, frequency details, or any other helpful forms of output.

In some embodiments of the invention the subscribers or users may be provided with an option to grade the perceived severity of the actual or potential unlawful act that they are reporting. This, and the other selection criteria from the menu, enables information to be received by the central processor in a partially organised or partially processed format.

To motivate subscribers or users to send information on an actual or potential unlawful act to the central processor a regular lottery style draw may be made, with a prize being given to a subscriber or user who has sent reliable, useful, or accurate, information to the central processor. The draw may be arranged so that each time a particular subscriber or user sends information to the central processor they receive a chance of being drawn (eg receive a Lottery ticket or ticket number). A subscriber or user who sends information twice within a pre-determined period would receive two chances, etc. As a further incentive to subscribers or users, a reward may be shared among those who have contributed to the identification of perpetrators of an unlawful act. To assist in maintaining the integrity of information received by the central processor subscribers or users may be disqualified from the draw if they are found to have deliberately sent false or inaccurate information. Legislation may also provide that it is an offence to deliberately send inaccurate information.

It will be appreciated that the invention can be used to mobilise large portions of a population to assist authorities in preventing and punishing unlawful acts. Additionally, the invention may facilitate the quick and cost efficient gathering and processing of extremely large amounts of information. In some embodiments of the invention Governments may mandate that all mobile telephones be manufactured with means to communicate with the central processor, and thus enable participation in working to prevent, discourage, or punish unlawful acts. The invention may also be used as a means of assisting authorities to find missing persons, etc.

In some embodiments of the invention the information from subscribers or users gathered and/or processed may be exchanged between various law enforcement bodies—for example information may be exchanged and collated between the United States FBI, the CIA, and the military. By combining information held by several organisations more informative or more reliable assessments can be made relating to unlawful acts and the perpetrators or potential perpetrators thereof.

The invention may be utilised in association with media campaigns which sensitise the general public to the benefits of sending information on an actual or potential unlawful act. Such campaigns may also involve instructing the general public as to what to look for in terms of identifying unlawful behaviour. In some embodiments the invention may have the effect of reducing terrorism, crime generally, and traffic offences, while at the same time encouraging growth in the telecommunications industry.

Referring to FIG. 1 hereof, there is shown a flow chart exemplifying the way a menu may appear on the screen of a subscriber's or user's mobile telephone, with options for entering information dealing with specific traffic or vehicle related offences or the like.

In some related applications of the invention subscribers or users can be electronically polled via mobile telephones for information as to their preferences or experiences with consumer products, political parties, etc. The polling can be arranged with multi-tier questions similar in principle to the multi-tier questioning discussed above. The information received in an electronic format can be processed to produce market research reports, political opinion polls, etc. The polling may involve questions and answers communicated by way of text or electronic voice recognised communications.

It will be appreciated by those skilled in the art that the invention facilitates widespread collection of information in a form suitable for efficient processing, and with minimum paid human input.

It should be appreciated that in some embodiments of the invention the mobile telephones used by subscribers or users may have a voice recognition facility so that data can be recorded in the mobile telephone by converting spoken words into digital data. Additionally, the invention may also function with non-mobile telephones, palmtop computers, or various suitable other means of communication.

Preferably the mobile telephones used with the invention are WAP type telephones, although this is not essential.

In some embodiments of the invention the mobile telephones may be of a type that have a downloadable menu for use in gathering information. The mobile telephones may be such that they can conveniently remain online for long periods of time and can access internet web sites. This may be distinguishable from mobile telephones where the menus for use in gathering information are a permanent part of each cellular phone.

In further embodiments of the invention the mobile telephones may have global positioning technology or similar. In this embodiment law enforcement authorities can send unsolicited messages to mobile telephone users known by way of the positioning technology to be in the vicinity of a crime as or shortly after it occurs. The users can be asked to look out for and report on certain events, or individuals, etc.

While some preferred aspects or embodiments of the invention have been described by way of example, it should be appreciated that modifications and improvements can occur without departing from the scope of the following claims.

1-32. Cancelled.

33. A process for forming a profile of actual or potential unlawful acts, or actual or suspected perpetrators thereof, comprising the steps of:
i) arranging a processor means such that it is able to receive communications from subscribers or users of a communications network,
ii) receiving communications at the processor means from communications devices of the subscribers or users, the communications each comprising information as to an actual or potential unlawful act,
iii) processing the information by way of the processor means such that a profile is developed to characterise the act and/or the actual or suspected perpetrator(s) of the act, and
iv) reporting the profile to an interested authority.

34. A process according to claim 33, wherein the communications devices are mobile communications devices.

35. A process according to claim 33, wherein the communications devices mentioned at step ii) comprise mobile telephones.

36. A process according to claim 33, wherein the communications devices mentioned at step ii) comprise WAP phones.

37. A process according to claim 33, wherein the communications devices mentioned at step ii) comprise palmtop computers.

38. A process according to claim 33, wherein the communications devices comprise mobile telephones and wherein at least some of the communications received at the processor means at step ii) are in a non-voice digital form.

39. A process according to claim 33, wherein at least some of the communications received at the processor means at step ii) are in the form of text messages.

40. A process according to claim 33, wherein at least some of the communications received at the processor at step ii) are in a voice form but are subsequently converted to a digital form by voice recognition means within the processor means.

41. A process according to claim 33, wherein the communications devices comprise mobile telephones and wherein the processing of the information at step iii) involves:
a) comparing the information from at least some of the communications against predetermined criteria to ascertain whether the information is a match against such criteria, and/or
b) comparing the information from at least some of the communications with information from others of the communications to ascertain a match therebetween,
and using the match or matches to substantially electronically develop the profile.

42. A process according to claim 33, wherein the communications devices comprise mobile telephones and wherein at least some of the communications devices have a screen viewable menu for enabling selection of categories of unlawful acts such that when a category is selected at one of the communications devices, subsequent communications from that communications device are received at the processor means at step ii) with an indicator as to which category was selected.

43. A process according to claim 33, wherein the communications devices comprise mobile telephones and wherein at least some of the communications devices have a screen viewable menu for enabling selection of categories of unlawful acts such that when a category is selected at one of the communications devices, subsequent communications from that communications device are received at the processor means at step ii) with an indicator as to which category was selected, and wherein the screen viewable menu can be downloaded to at least some of the communications devices from the processor means.

44. A process according to claim 33, wherein the processor means comprises a computer or a number of interlinked computers.

45. A process according to claim 33, wherein the communications devices comprise mobile telephones, and wherein the process comprises the further step of the processor means contacting at least some of the subscribers or users by way of their communications devices and requesting or prompting for additional information regarding the actual or potential unlawful act that they communicated to the processor means at step ii), and then receiving and processing a response from those subscribers or users.

46. A process according to claim 33, wherein the communications devices comprise mobile telephones, and wherein the process comprises the further step of the processor means contacting at least some of the subscribers or users by way of their communications devices and requesting or prompting for additional information regarding the actual or potential unlawful act that they communicated to the processor means at step ii), and then receiving and processing a response from those subscribers or users, and wherein said further step occurs before and/or after step iii).

47. A process according to claim 33, wherein the communications devices comprise mobile telephones, and wherein the process comprises the further step of the processor means contacting at least some of the subscribers or users by way of their communications devices and requesting or prompting for additional information regarding the actual or potential unlawful act that they communicated to the processor means at step ii), and then receiving and processing a response from those subscribers or users, and wherein said further step involves sending the subscribers or users a communications device screen viewable question or questions which can be answered by manipulating keypad keys of the respective communications device.

48. A process according to claim 33, wherein the communications devices comprise mobile telephones, and wherein the process comprises the further step of the processor means contacting at least some of the subscribers or users by way of their communications devices and requesting or prompting for additional information regarding the actual or potential unlawful act that they communicated to the processor means at step ii), and then receiving and processing a response from those subscribers or users, and wherein said further step involves sending the subscribers or users a communications device screen viewable question or questions which can be answered by manipulating keypad keys of the respective communications device, and wherein said further step involves sending images of suspected perpetrators, places, or objects considered potentially relevant to an unlawful act under investigation by the interested authority.

49. A process according to claim 33, wherein the communications devices comprise mobile telephones, and wherein at least some of the subscribers or users are automatically identified by the processor means when such subscribers or users send communications to the processor means.

50. A process according to claim 33, wherein the communications devices comprise mobile telephones, and wherein the processing of the information at step iii) involves assessing the reliability of information from the communications received at the processor means, and discarding information from certain of the subscribers or users if it is deemed unreliable.

51. A process according to claim 33, wherein the communications devices comprise mobile telephones, and, wherein the processor means keeps a record of at least some of the subscribers or users who have provided information to the processor means and allocates such subscribers or users to receive compensation for participation in the process.

52. A process according to claim 33, wherein the communications devices comprise mobile telephones, and wherein the processor means keeps a record of at least some of the subscribers or users who have provided information to the processor means and allocates such subscribers or users to receive compensation for participation in the process wherein the compensation comprises a chance to win a prize in a lottery.

53. A process according to claim 33, wherein the profile is communicated to a further interested authority and is assessed against information held by that further authority to enhance or supplement the profile.

54. A process according to claim 33, wherein the communications devices comprise mobile telephones, and wherein the interested authority is, or if appropriate the interested authorities are each, a law enforcement authority.

55. A process according to claim 33, wherein the communications devices comprise mobile telephones, and wherein the processor means stores a case history of actual or suspected perpetrators of unlawful acts based on the communications received at step ii).

56. A process according claim 33, comprising:
i) arranging the processor means to maintain a medical database of patients being monitored in terms of their medical condition,
ii) receiving medical communications for the patients at the processor means, the medical communications each containing update medical information personal to the respective patient,
iii) processing the update medical information and updating the medical database for the respective patient, and
iv) reporting updated database details for at least some of the patients.

57. A process according to claim 33, wherein the process also involves:
i) receiving political communications from members of the public at the processor means, the political communications each containing political information as to which political candidate and/or which political party the members of the public intend to vote for at an upcoming political election,
ii) processing the political information to obtain a political opinion poll result, and
iii) reporting the opinion poll result to an interested party.

58. A process according to claim 33, wherein the process also involves:
i) receiving consumer product or service communications from consumers at the processor means, the consumer product or service communications containing preference information as to the consumer's preferences with regard to specific products or services,
ii) processing the preference information to obtain a consumer product or service market report, and
iii) reporting the market report to an interested party.

59. An item of software forming part of the processor means of claim 33, or for combining with the processor means of claim 33, such that the processor means functions to achieve the process of any one of the preceding claims.
